(19) United States
(12) Patent Application Publication
(10) Pub. No.: US 2011/0031433 A1
(43) Pub. Date: Feb. 10, 2011

(54) THERMOSETTING EPOXY RESIN, A COMPOSITE MATERIAL, A METHOD OF FORMING A COMPOSITE MATERIAL ARTICLE, A MOULD AND A METHOD OF MAKING A MOULD

(75) Inventor: Peter Burchell, Bristol (GB)

Correspondence Address: LOWE HAUPTMAN HAM & BERNER, LLP, 1700 DIAGONAL ROAD, SUITE 300, ALEXANDRIA, VA, 22314, US

(73) Assignee: AIRBUS OPERATIONS LIMITED, Bristol (GB)

(21) Appl. No.: 12/936,928

(22) PCT Filed: May 11, 2009
(86) PCT No.: PCT/GB09/50499

§ 371 Date: Oct. 8, 2010

(30) Foreign Application Priority Data
May 13, 2008 (GB) 0808636.5

(51) Int. Cl. H01F 1/00; B29C 35/08; B29C 33/38; B82Y 99/00

(52) U.S. Cl. 252/62.56; 425/174.4; 264/219; 977/742

(57) ABSTRACT

A thermosetting epoxy resin includes particles of magnetite and conductive carbon to act as microwave susceptors. A composite material comprises a thermosetting epoxy resin matrix phase with particles of magnetite and a carbon fibre reinforcement phase. A mould for a composite article comprises a mould body made from a material that is substantially transparent to microwaves with a surface or rear surface layer including microwave radiation absorbing material.

### FIELD OF THE INVENTION

The present invention relates to the field of thermosetting composite materials. In particular, the invention relates to the field of microwave curing of thermosetting composite materials.

### BACKGROUND OF THE INVENTION

The thermal curing of fibre/epoxy composites in a single-sided mould is an established industrial technique. The thermal curing is performed by applying thermal energy, normally by hot air convection in an oven or autoclave. This process is slow and a lot of energy is used to heat the air and equipment. The hot air must subsequently be vented and the hot equipment cooled. Also, because the equipment takes time to reach the relevant temperature, there is more time for the tool face to expand due to thermal expansion. That can introduce error in the shape of the final article.

It is known to use electromagnetic energy to cure epoxy resins in a shorter time. The advantage of using electromagnetic energy, for example radio wave or microwave energy to cure the epoxy resin is that only the epoxy itself is heated, resulting in a significant energy saving. Also, because the mould itself does not become too hot, due to the shorter curing time tolerance errors due to thermal expansion are reduced.

One example of microwave curing a thermoset polymer is shown in U.S. Pat. No. 4,626,642 in the name of General Motors Corporation. In that case a thermoset polymer is used as an adhesive in securing automotive plastics components together. The thermoset polymer comprises an epoxy with added steel or aluminium fibres or powder. Graphite fibres are described as an alternative additive.

Japanese Patent Publication No.5-79208 describes a method of microwave curing a reinforced plastic comprising an epoxy resin and a Kevlar fibre. U.S. Pat. No. 6,566,414 describes adding microwave exothermic accelerators. That document concerns itself with application of the resin composition to asphalt, concrete, slate etc.

It is an object of the invention to provide an improved thermosetting epoxy resin.

According to a first aspect of the invention there is provided a thermosetting epoxy resin including particles of magnetite and particles of conductive carbon material.

The combination of a conductive carbon material, for example graphite powder and magnetite has a beneficial and synergistic effect not seen in the single substance additive epoxies in the prior art. In particular, magnetite acts as an effective microwave susceptor above a critical temperature whilst carbon susceptors act from a lower temperature. By combining the two substances into a thermosetting epoxy resin, a resin material is provided which has good susceptibility to microwave heating from a cold start through to a thermosetting temperature.

It is an object of the invention to provide an improved composite material.

According to a second aspect of the invention there is provided a composite material comprising a thermosetting epoxy resin matrix including particles of magnetite and laid-up carbon fibre reinforcement.

The carbon fibre reinforcement material provides the low temperature microwave susceptibility whilst the inclusion of particles of magnetite in the thermosetting epoxy resin provides the microwave susceptibility at higher temperatures. Additional conductive carbon material could be added to the epoxy resin if necessary.

It is an object of the invention to provide an improved method of forming a composite material article.

According to a third aspect of the invention there is provided a method of forming a composite material article comprising the steps of providing a matrix material comprising at least a thermosetting epoxy resin including magnetite particles, providing a mould of substantially microwave transparent material, providing a carbon fibre reinforcement material, laying-up the matrix material and the reinforcement material in the mould and applying microwave radiation to the laid-up material to effect thermosetting of the resin.

In that way microwave heating of the resin effects thermosetting and the present of magnetite particles together with the presence of the carbon fibre reinforcement material provides the synergistic microwave susceptor effect of the combination of carbon and magnetite described above.

According to a fourth aspect of the invention there is provided a mould for moulding a composite material article comprising a mould body formed of material which is substantially transparent to microwave radiation and a tool face having microwave susceptors on or adjacent the working surface thereof.

In that way, when a composite material is laid-up on the mould and microwave energy is applied, minimal microwave energy is absorbed by the mould itself but by providing microwave suspectors on or adjacent the mould surface, microwave energy will be absorbed locally and local heating will occur which encourages thermosetting of at least the outer mould line of the composite material.

According to a fifth aspect of the invention there is provided a method of making a mould for moulding a composite material article comprising the steps of providing a mould body of substantially microwave transparent material, providing a tool face and incorporating into the tool face or applying to the working surface of the tool face, microwave radiation absorbing material.

Further advantages of the invention are set out in the claims appended hereto.

### BRIEF DESCRIPTION OF THE DRAWINGS

Embodiments of the various aspects of the invention will now be described in detail, by way of example, and with reference to the accompanying drawings, in which:-

FIGS. 1a and 1b are schematic representations of the matrix and reinforcement phases of a fibre reinforced composite material,

FIG. 2 is a schematic representation of the composite material,

FIG. 3 is a schematic sectional view through a mould in accordance with the invention,

FIG. 4 is a schematic sectional view through another mould in accordance with the invention, and

FIG. 5 is a schematic sectional view through the mould of FIG. 4 shown with a composite material laid-up on the mould.

### DETAILED DESCRIPTION OF THE EMBODIMENTS

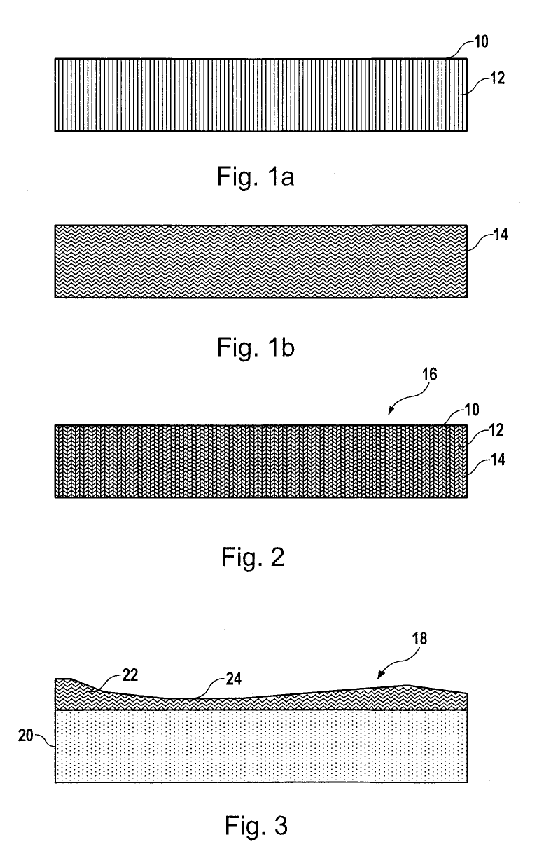

In FIG. 1a and 1b the separate matrix and reinforcement phases of a carbon fibre composite material are shown. The matrix phase 10 comprises a thermosetting epoxy resin having magnetite particles 12 dispersed therein in the range 1-5% by volume. The magnetite particles are preferably sized in the range 5-100 nanometres.

The resin and magnetite mix can be formed by providing an initial master batch of resin with a high concentration of magnetite powder which is subsequently mixed into a greater volume of resin to provide the preferred proportion of magnetite by volume in the resin.

FIG. 1b shows a carbon fibre reinforcing phase 14 of the composite carbon fibre material. The carbon fibre reinforcement phase is typically made from graphite fibre which is formed into a yarn and then woven in a variety of different patterns.

The composite carbon fibre/epoxy material occurs when the carbon fibre reinforcement phase 14 is combined with the epoxy matrix phase. The combination of those two can occur prior to moulding, for example in a so-called “pre-preg” process. Alternatively, the combination of the epoxy with the carbon fibre can occur when laying-up material in a mould.

It is noted that by applying microwave radiation to the aforementioned carbon fibre/epoxy/magnetite material, the graphite filaments in the carbon fibre act from cold as a microwave susceptor, by which it is meant that they absorb microwave energy and convert that energy to heat, heating the epoxy matrix material which surrounds the carbon fibre. That, in turn, heats the magnetite powders and, after a certain amount of heating, the magnetite particles also act as microwave susceptors. The synergist combination of magnetite and carbon fibre in reasonably close thermal proximity is particularly useful in the application of thermosetting epoxy resin by application of microwave energy. By providing microwave susceptors in the composite material, the amount of microwave energy that is required to be applied to a particular composite material mould is reduced.

Although it is expected that the carbon fibre which exists in the composite material will be sufficient to act as a microwave suspector from cold, it may be necessary to add additional carbon either in the form of graphite powder or carbon nanotubes. In that case, the additional carbon material added into the thermosetting epoxy resin shall comprise a proportion by volume in the range 0.5% to 2%. Graphite powder in the form of carbon black of 10-60 nm could be used. Carbon nanotubes with a diameter of 5-20 nm and a length of 1-100 nm could be used.

It is preferred that the total, by volume, of microwave susceptor additives to the epoxy resin should be no more than 5%.

Turning to FIG. 3, a mould 18 comprises a mould base body 20 and a mould tool face 22 mounted on the mould base body 20. The mould tool face 22 has an outer surface 24, against which the outer mould line of a composite carbon fibre reinforced material will lie.

In the embodiment of FIG. 3, the mould base body 20 is formed from a material which is relatively transparent to microwaves, by which we mean microwave energy is not readily absorbed by the material of the mould base body 20. Typically, the microwave transparent material will comprise a ceramic material. Most particularly a ceramic fibre material will form the mould base body 20. The mould tool face 22 is formed from a material which includes, most preferably at or adjacent the surface 24, a proportion of microwave susceptors, as described above.

In the example shown in FIG. 3, the mould tool face 22 is formed from a silicate/basalt fibre material with the addition of a microwave susceptor. The microwave susceptor could be graphite or a ferrite material, such as magnetite. That susceptor can be introduced into the silicate fibre by mixing when creating the mould tool face 22.

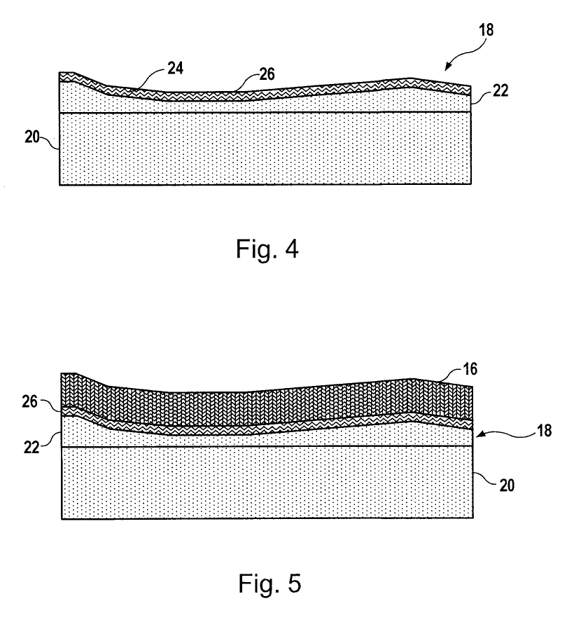

In FIG. 4 a mould 18 is shown which is substantially similar to the mould in FIG. 3 and parts corresponding to parts in FIG. 3 carry the same reference numerals.

As in the mould 18 of FIG. 3, the mould 18 of FIG. 4 comprises a mould base body 20 formed of a microwave transparent material, as described in relation to FIG. 3. In FIG. 4, the mould 18 has a mould tool face 22 mounted on the mould base body 20. In this case, the mould tool face 22 is also formed from a material which is substantially transparent to microwaves. In the mould 18 of FIG. 4, the mould surface 24 has a coating 26 which includes a proportion of microwave suspector material. The coating 26 or can be applied by dusting the mould surface 24, by powder coating the mould surface 24 or by painting an emulsion of a carrier and the microwave suspector material. The advantage of the FIG. 4 arrangement is the application of microwave energy to the mould 18 results in local heating only where the microwave susceptor material 26 is applied, ie at the surface 24 of the tool face 22 where the heat is most required to effect thermosetting. The remainder of the tool does not absorb microwave energy. In previous moulding arrangement, the mould 18 would be arranged in an autoclave and the entire autoclave and mould would need to be heated to reach the thermosetting temperature of the epoxy. In the present case, the mould is arranged inside a large microwave system and microwave energy is not absorbed by the rest of the mould. The great proportion of the microwave energy is absorbed by the microwave susceptible material which coats the surface of the mould and by the microwave susceptors in the carbon fibre reinforced composite material.

FIG. 5 shows the mould of FIG. 4 with a composite material comprising carbon fibre reinforcing material and an epoxy matrix with magnetite particles therein.

When the carbon fibre composite is laid-up on the mould, microwave energy is applied and the mould base body 20 and mould tool face 22 absorb little microwave radiation. Microwave susceptors, for example magnetite and/or graphite in the layer 26 coating the surface of the tool face 22, and the graphite and magnetite particles in the carbon fibre reinforced matrix absorb microwave energy and convert that to heat which acts to thermoset the epoxy matrix material.

The frequency of microwave radiation applied to the mould is preferably 2.45 GHz (approximately), which is the typical frequency of a domestic microwave oven.

1. A thermosetting epoxy resin including particles of magnetite and particles of conductive carbon material.

2. A thermosetting epoxy resin according to claim 1 in which the particles of magnetite have a size in the range 5-100 nanometres.

3. A thermosetting epoxy resin according to claim 1 in which the conductive carbon material comprises graphite powder.

4. A thermosetting epoxy resin according to claim 1 in which the conductive carbon material comprises carbon nano tubes.

5. A thermosetting epoxy resin according to claim 1 in which the conductive carbon material comprises a mixture of graphite powder and carbon nano tubes.

6. A thermosetting epoxy resin according to claim 1 in which the particles of magnetite are provided in the amount of 1% to 5% by volume to volume of the resin, most preferably 3% to 5%.

7. A thermosetting epoxy resin according to claim 1 in which the particles of conductive carbon material are provided in the amount 0.5% to 5% by volume to volume of resin, most preferably 0.5% to 2%.

8. A thermosetting epoxy resin according to claim 1 in which the particles of magnetite and conductive carbon material together form no more than 5% by volume to volume of resin.

9. A composite material comprising a thermosetting epoxy resin matrix including particles of magnetite and carbon fibre reinforcement.

10. A composite material according to claim 9 formed as a pre-preg material.

11. A composite material according to claim 9 further including particles of conductive carbon material.

12. A composite material according to claim 9, in which the particles of magnetite have a size in the range 5-100 nanometres.

13. A composite material according to claim 11, in which the conductive carbon material comprises graphite powder.

14. A composite material according to claim 11, in which the conductive carbon material comprises carbon nano tubes.

15. A composite material according to claim 11, in which the conductive carbon material comprises a mixture of graphite powder and carbon nano tubes.

16. A composite material according to claim 11, in which the particles of magnetite are provided in the amount of 1% to 5% by volume to volume of the resin, most preferably 3% to 5%.

17. A composite material according to claim 11, in which the particles of conductive carbon material are provided in the amount 0.5% to 5% by volume to volume of resin, most preferably 0.5% to 2%.

18. A composite material according to claim 11, in which the particles of magnetite and conductive carbon material together form no more than 5% by volume to volume of resin.

19. A method of forming a composite material article comprising the steps of providing a matrix material comprising at least a thermosetting epoxy resin and magnetite particles, providing a mould of substantially microwave transparent material, providing a carbon fibre reinforcement material, laying up the matrix material and the reinforcement material in the mould and applying microwave radiation to the laid-up material to effect thermosetting of the resin.

20. A mould for moulding a composite material article comprising a mould body formed of material which is substantially transparent to microwave radiation and a tool face having microwave radiation absorbing material on or adjacent the working surface thereof.

21. A method of making a mould for moulding a composite material article comprising the steps of providing a mould body of substantially microwave transparent material, providing a tool face and incorporating into the tool face or applying to the working surface of the tool face, microwave radiation absorbing material.

22. A method of making a mould according to claim 21, in which the step of applying microwave radiation absorbing material to the working surface of the tool face comprises coating the working surface of the tool face with microwave radiation absorbent material, either by painting, by powder coating or by dusting before moulding.

23. A method of making a mould for moulding a composite article according to claim 22 in which the step of incorporating microwave radiation absorbing material into the tool face comprises adding microwave radiation absorbing material into a ceramic used to forming the tool face.

24. A method of forming a composite material article, a mould for moulding a composite material article and the method of making a mould for moulding the composite material article according to claim 19 in which the mould body of substantially microwave transparent material comprises a silicate ceramic.

25. A mould or a method of making a mould for moulding a composite material article, according to claim 20, in which the microwave radiation absorbing material comprises one or both of particles of magnetic or conductive carbon material.
